(19) United States
(12) Patent Application Publication
(10) Pub. No.: US 2009/0125280 A1
(43) Pub. Date: May 14, 2009

(54) Methods for geomechanical fracture modeling

(75) Inventors: Mohamed Y. Soliman, Cypress, TX (US); Loyd E. East, JR., Tomball, TX (US); Dwight D. Fulton, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 11/985,082

(22) Filed: Nov. 13, 2007

(51) Int. Cl. G06F 17/50

(52) U.S. Cl. 703/1

(57) ABSTRACT

The present invention relates generally to methods for designing and optimizing the number, placement, and size of fractures in a subterranean formation and more particularly to methods that account for stress interference from other fractures when designing and optimizing the number, placement, and size of fractures in the subterranean formation. The present invention optimizes the number, placement and size of fractures in a subterranean formation. The present invention determines one or more geomechanical stresses induced by each fracture based on the dimensions and location of each fracture, including surface deformations caused by each fracture. The present invention determines a maximum number of fractures and a predicted stress field based on the geomechanical stresses induced by each of the fractures.

### CROSS-REFERENCE TO RELATED APPLICATIONS

This application is related to U.S. patent application Ser. No. 10/728,295, filed Dec. 4, 2003.

### BACKGROUND OF THE INVENTION

The present invention relates generally to methods for designing and optimizing the number, placement, and size of fractures in a subterranean formation and more particularly to methods that account for stress interference from other fractures when designing and optimizing the number, placement, and size of fractures in the subterranean formation.

One method typically used to increase the effective drainage area of well bores penetrating geologic formations is fracture stimulation. Fracture stimulation comprises the intentional fracturing of the subterranean formation by pumping a fracturing fluid into a well bore and against a selected surface of a subterranean formation intersected by the well bore. The fracturing fluid is pumped at a pressure sufficient that the earthen material in the subterranean formation breaks or separates to initiate a fracture in the formation.

Fracture stimulation can be used in both vertical and horizontal wells. Fracturing horizontal wells may be undertaken in several situations, including situations where the formation has: 1. restricted vertical flow caused by low vertical permeability or the presence of shale streaks;

2. low productivity due to low formation permeability;

3. natural fractures in a direction different from that of induced fractures, thus induced fractures have a high chance of intercepting the natural fractures; or

4. low stress contrast between the pay zone and the surrounding layers. In the fourth case, a large fracturing treatment of a vertical well would not be an acceptable option since the fracture would grow in height as well as length. Drilling a horizontal well and creating either several transverse or longitudinal fractures may allow rapid depletion of the reservoir through one or more fractures. Shown in FIG. 1 is a perspective view of a well bore 100 comprising lateral 104. The lateral 104 comprises three fractures 106, 108, and 110. Depending on the orientation of the lateral 104 to the direction of minimal stress- the fractures 106, 108, and 110 may be transverse or axial fractures. If the lateral 104 is drilled in direction of minimal stress, then the fractures 106, 108, and 110 ale orientated perpendicular to the direction of minimal stress and are referred to as transverse fractures. If the lateral 104 is drilled perpendicular to the direction of minimal stress, then the fractures 106, 108, and 110 are orientated parallel to the direction of minimal stress and are referred to as axial fractures.

Each of the fractures 106, 108, and 110 typically has a narrow opening that extends laterally from the well bore. To prevent such opening from closing completely when the fracturing pressure is relieved, the fracturing fluid typically carries a granular or particulate material, referred to as “proppant,” into the opening of the fracture and deep into the fracture. This material remains in each of the fractures 106, 108, and 110 after the fracturing process is finished. Ideally, the proppant in each of the fractures 106, 108, and 110 holds apart the separated earthen walls of the formation to keep the fracture open and to provide flow paths through which hydrocarbons from the formation can flow into the well bore at increased rates relative to the flow rates through the unfractured formation. Fracturing processes are intended to enhance hydrocarbon production from the fractured formation. In some circumstances, however, the fracturing process may terminate prematurely, for a variety of reasons. For example, the “pad” portion of the fracturing fluid, which is intended to advance ahead of the proppant as the fracture progresses, may undesirably completely “leak off” into the formation, which may cause the proppant to reach the fracture tip and create an undesirable “screenout” condition. Thus, properly predicting fracture behavior is a very important aspect of the fracturing process.

In the past, fracturing typically took place in well bores that were cased and perforated. The total number of fractures was a limited number per lateral in the case of fracturing horizontal wells and the fractures had sufficient space between each other such that stress interference between the fractures was minimal. With the advent of new fracturing technologies such as SURGIFRAC provided by Halliburton Energy Services, fractures may be placed in open hole well bores. Furthermore, it is now feasible and cost-effective to place many more fractures in a well bore. When many fractures are induced in a well bore, the geomechanical stress caused by fractures on each other can no longer be ignored. Current fracturing modeling methods, however, do not account for geomechanical stresses caused by one fracture on another.

### SUMMARY OF THE INVENTION

The present invention relates generally to methods for designing and optimizing the number, placement, and size of fractures in a subterranean formation and more particularly to methods that account for stress interference from other fractures when designing and optimizing the number, placement, and size of fractures in the subterranean formation.

One embodiment of the present invention includes a method of optimizing a number, placement and size of fractures in a subterranean formation, comprising the steps of (a) determining one or more geomechanical stresses induced by each fracture based on the dimensions and location of each fracture; (b) determining a geomechanical maximum number of fractures based on the geomechanical stresses induced by each of the fractures; (c) determining a predicted stress field based on the geomechanical stresses induced by each fracture; and (d) determining a predicted surface deformation caused by each fracture.

Another embodiment of the present invention includes a computer program, stored on a tangible storage medium, for optimizing a number, placement and size of fractures in a subterranean formation, the program comprising executable instructions that cause at lest one processor to (a) determine one or more geomechanical stresses induced by each fracture based on the dimensions and location of each fracture; (b) determine a geomechanical maximum number of fractures based on the geomechanical stresses induced by each of the fractures; (c) determine a predicted stress field based on the geomechanical stresses induced by each fractures and (d) determine a predicted surface deformation caused by each fracture.

Another embodiment of the present invention includes a method of fracturing a subterranean formation, comprising the step of: optimizing a number, placement and size of fractures in the subterranean formation, the step of optimizing comprising: (a) determining one or more geomechanical stresses induced by each fracture based on the dimensions and location of each fracture; (b) determining a geomechanical maximum number of fractures based on the geomechanical stresses induced by each of the fractures; (c) determining a predicted stress field based on the geomechanical stresses induced by each fracture; and (d) determining a predicted surface deformation caused by the each fracture.

The features and advantage of the present invention will be readily apparent to those skilled in the art upon a reading of the description of the preferred embodiments which follows.

### BRIEF DESCRIPTION OF THE DRAWINGS

The present invention is better understood by reading the following description of non-limitative embodiments with reference to the attached drawings wherein like parts of each of the several figures are identified by the same referenced characters, and which are briefly described as follows:

FIG. 1 is a perspective view of a subterranean well bore with a lateral having fractures.

FIG. 2 illustrates a process flow diagram from an exemplary method of the present invention for fracturing based on a fracture layout.

FIG. 3 illustrates a process flow diagram for an exemplary method of the present invention for determining an optimal number of fractures.

FIG. 4 illustrates a process flow diagram for an exemplary method of the present invention for estimating a cost-effective number of fractures.

FIG. 5 illustrates a process flow diagram for an exemplary method of the present invention for estimating a geomechanical maximum number of fractures.

FIG. 6 illustrates a process flow diagram for an exemplary method of the present invention for modeling fractures.

FIG. 7 illustrates a process flow diagram from an exemplary method of the present invention for modeling a fracture.

FIG. 8 is a graphical representation of the principal components of stress induced by a semi-infinite fracture versus dimensionless distance.

FIG. 9 is a graphical representation of the principal components of stress induced by a penny-shaped fracture versus dimensionless distance.

FIG. 10 is a graphical representation of the principal components of stress induced by a semi-infinite fracture and a penny-shaped fracture versus dimensionless distance.

FIG. 11 illustrates a coordinate system used by an exemplary method of the present invention for modeling surface deformation.

FIG. 12 depicts a side cross-sectional view of a subterranean well bore wherein fluid may be injected, and the results of such injection monitored, according to an exemplary embodiment of the present invention.

FIG. 13 illustrates a process flow diagram for an exemplary method of the present invention for measuring real-time fracturing data.

FIG. 14 illustrates an exemplary method of the present invention for fracturing based on real-time fracturing data.

It is to be noted, however, that the appended drawings illustrate only typical embodiments of this invention and are therefore not to be considered limiting of its scope, as the invention may admit to other equally effective embodiments.

### DETAILED DESCRIPTION OF THE INVENTION

The present invention relates generally to methods for designing and optimizing the number, placement, and size of fractures in a subterranean formation and more particularly to methods that account for stress interference from other fractures when designing and optimizing the number, placement, and size of fractures in the subterranean formation. The present invention may be applied to vertical or horizontal wells. Furthermore, the present invention may be used on cased well bores or open holes.

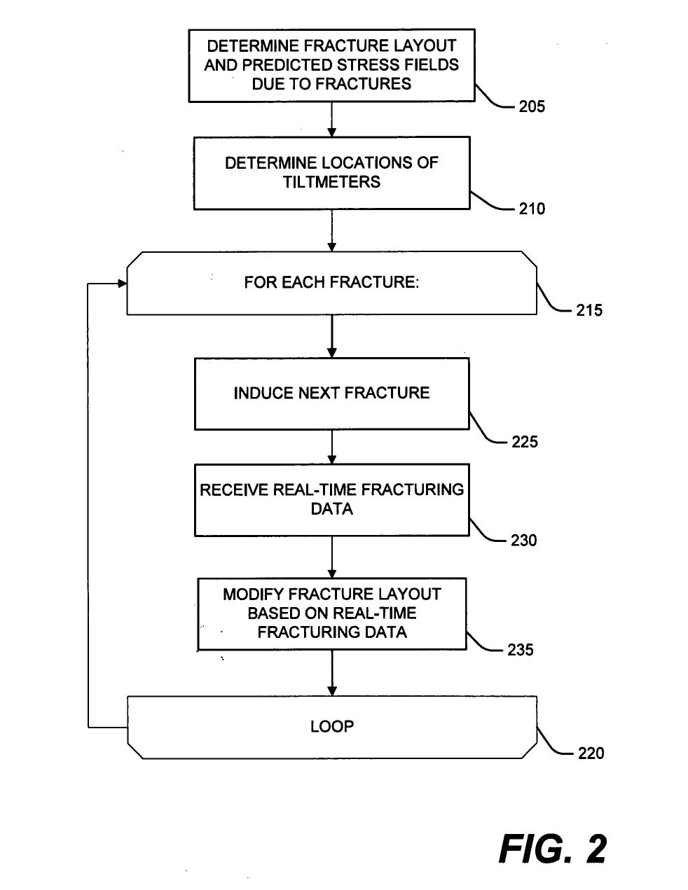

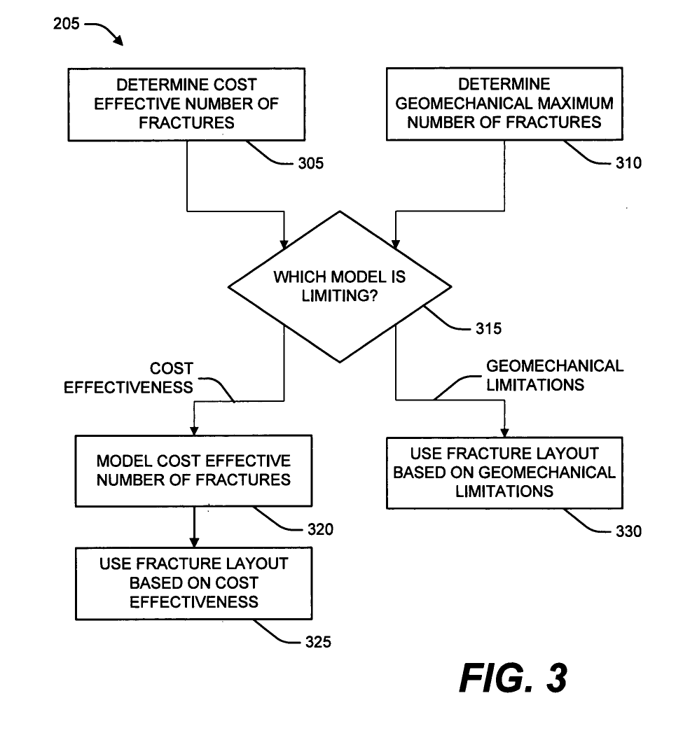

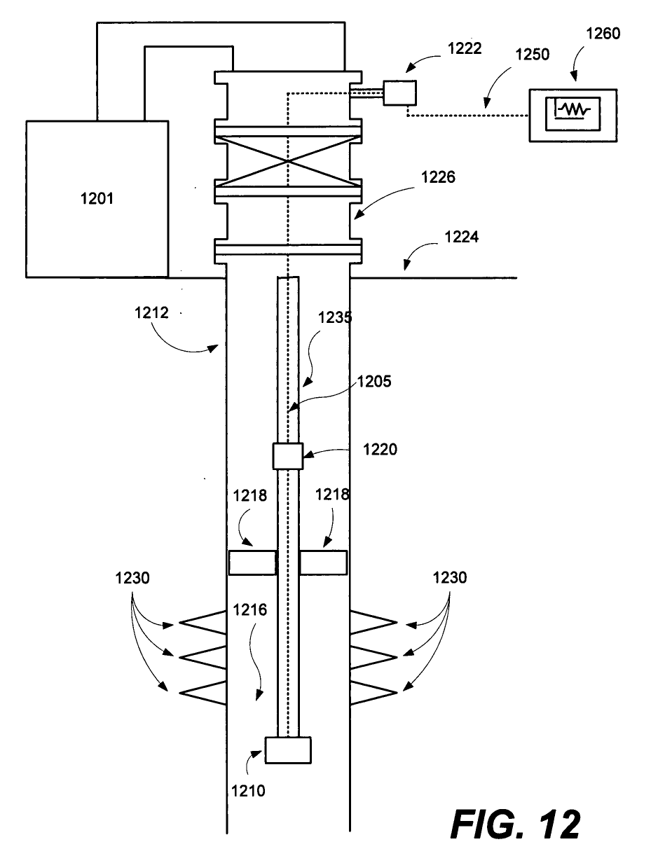

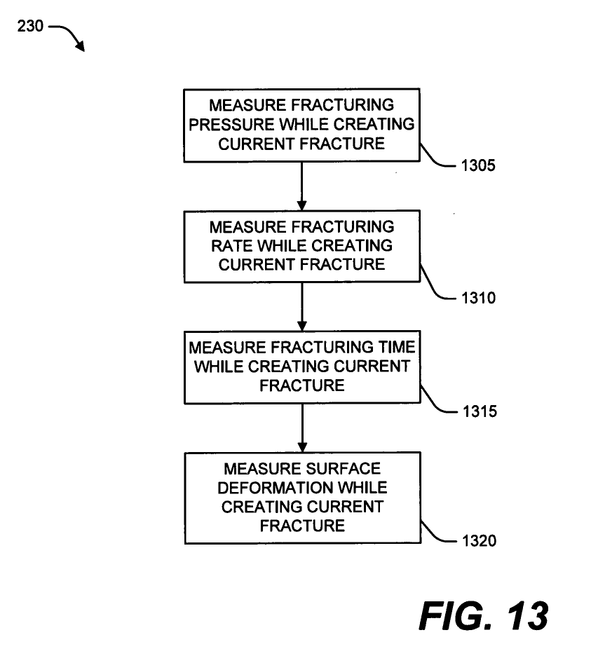

FIG. 2 depicts a flow chart of an exemplary embodiment of the methods according to the present invention. The method determines a fracture layout and one or more predicted stress fields due to the predicted fractures (block 205, which is shown in greater detail in FIG. 3). The method determines the locations of one or more tiltmeters to measure surface deformation caused by the predicted fractures (block 210). The method enters a loop and loops once for each fracture induced in the formation (blocks 215 and 220). Within the loop, the method induces a next fracture (block 225) and receives real-time fracturing data (block 230, which is shown in greater detail in FIG. 12). The method modifies the fracture layout based on the real-time fracturing data (block 235, which is shown in greater detail in FIG. 13).

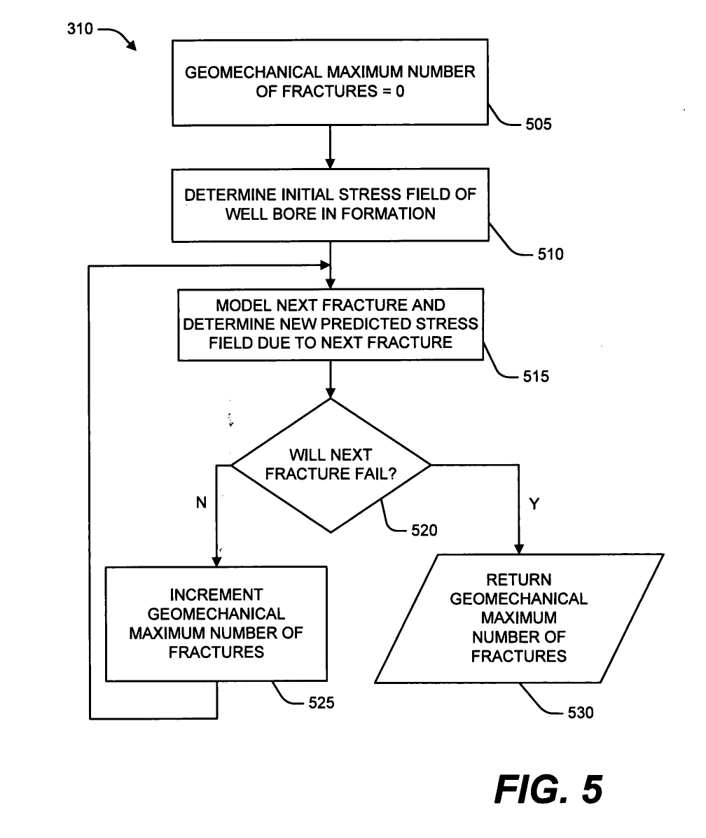

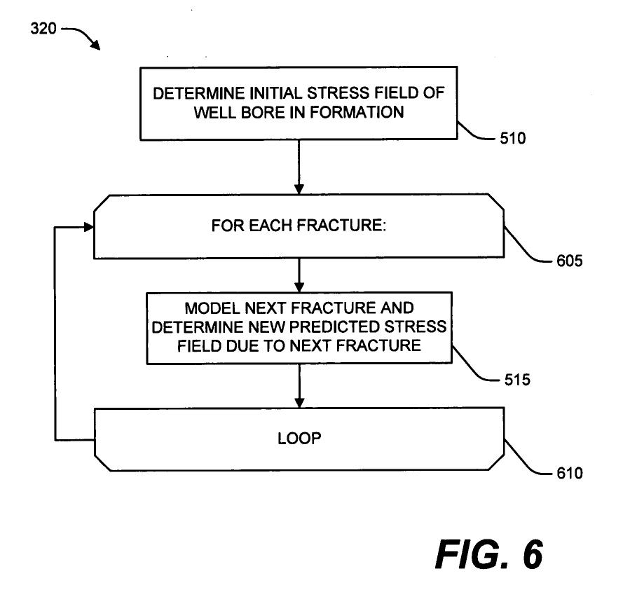

An example method for determining a predicted fracture layout is shown in FIG. 3. The example method includes determining a cost-effective number of fractures (block 305, which is shown in greater detail in FIG. 5). The method further includes determining a geomechanical maximum number of fractures (block 310, which is shown in greater detail in FIG. 6). The method includes determining which model (i.e., geomechanical or cost-effective) is limiting. If the cost-effective number of fractures is limiting the method includes modeling the cost effective number of fractures (block 320, which is shown in greater detail in FIG. 6) and using the fracture layout based on the cost-effective number of fractures (block 325). If, however, the geomechanical maximum number of fractures is limiting, the method includes using the fracture layout based on the geomechanical limitations (block 330).

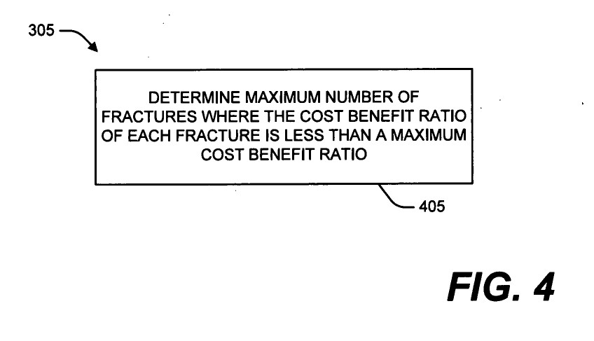

Referring now to FIG. 4, step 305 (FIG. 3), in which the method according to the present invention determines the cost-effective number of fractures, is shown in greater detail. The method includes determining the maximum of fractures for which the cost benefit ratio of each fracture is less than a maximum cost benefit ratio (block 405). The maximum cost-benefit ratio may be set by the user on a case-by-case basis or may be a default value.

Referring to FIG. 2, each of the fractures 106, 108, and 110 has all associated increase in production. Typically, the associated increase in production of a next modeled fracture is smaller than the increase in production associated with a previously modeled fracture. The increase in production of each additional fracture may be calculated based on any conventional method. In an exemplary embodiment of the present invention, the method may consider some or all of the following criteria to determine the increase in production for the next fracture: physical properties of the formation (e.g., horizontal and vertical permeability, whether anisotropy is present, whether the formation if homogeneous or heterogeneous, vertical lithological definitions including layers and shale streaks, and a leak off coefficient), physical properties of the reservoir (e.g., pressure, porosity, height, temperature, formation compressibility, fluid saturation, a type of fluid in the reservoir, and properties of the fluid in the reservoir), a definition of the stress field (e.g., a minimum horizontal stress in a pay zone and surrounding zones and a stress orientation of the formation), and mechanical properties of the rock in the formation (e.g., a Young's modulus due to the rock and a Poisson's ratio due to the rock).

In general, the cost of each additional fracture is determined by adding all costs associated with the next modeled fracture. In an exemplary embodiment, the cost-benefit ratio of each fracture is determined by dividing the estimated cost associated with the next modeled fracture by the estimated increase in production associated with the next modeled fracture.

The methods of the present invention may use metrics other than cost-benefit ratio for optimizing the number of fractures. For example, the method of the present invention may use other financial parameters including a net present value (NPV) of each fracture, a pay-out time of each of the fractures, or other financial parameters of creating each of the fractures.

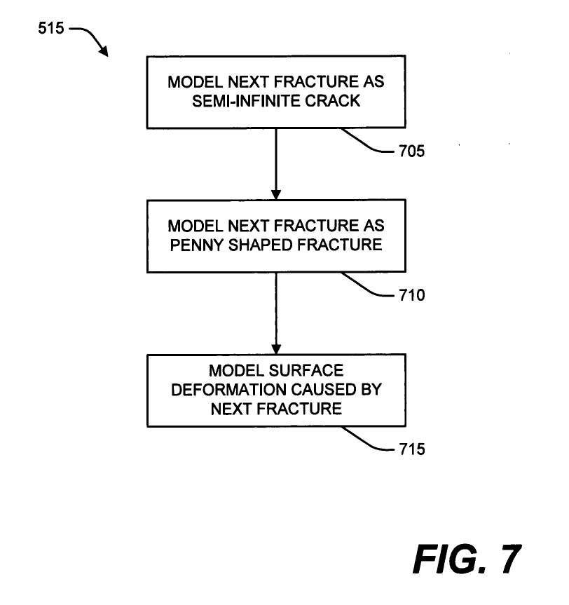

An example method of determining the geomechanical maximum number of fractures (block 310) is shown in FIG. 5. The method includes setting the geological maximum number of fractures to zero (block 505) and determining an initial stress field of the well bore in the geological formation (block 510). The method includes modeling a next fracture and determining a new predicted stress field due to the next fracture (block 515, which is shown in greater detail in FIG. 7). The method determines if the next modeled fracture will fail (block 520). If the next modeled fracture fails, the method includes returning the geological maximum number of fractures (block 530). Otherwise, the method includes incrementing the geomechanical maximum number of fractures (block 525) and returning to block 515.

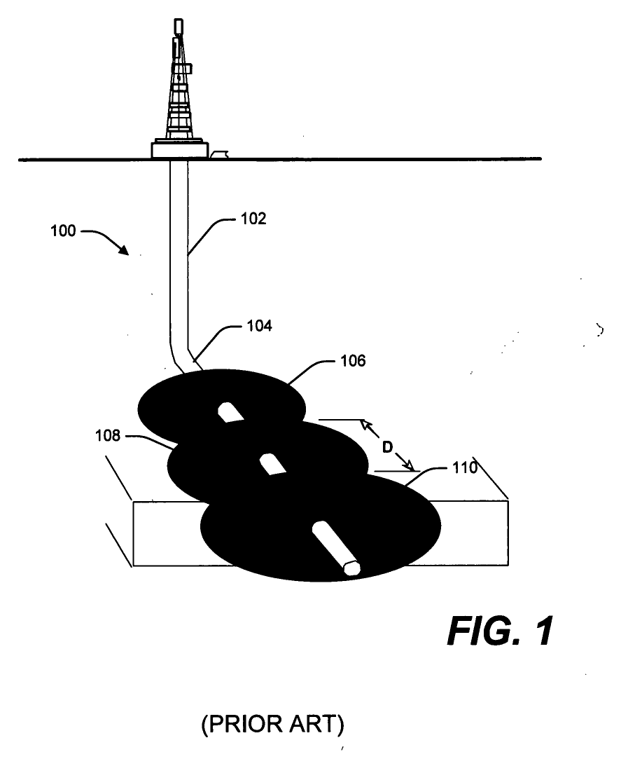

In step 510, the method determines an initial stress field of the well bore in the geological formation. Referring to FIG. 1, the initial stress field on well bore 100 maybe input by the user or determined by any conventional method including sampled data from the formation including microfracturing test data, minifracturing test data, leak-off test (LOT) data, or logging data. In an exemplary embodiment of the present invention wavelet analysis is used to determine the stresses from microfracturing or minifracturing test data. The method then determines the orientation of the vertical portion 102 to the initial stress field. The orientation of the vertical portion 102 may be input by the user or the method may determine the orientation of the vertical portion 102. In an exemplary embodiment of the present invention, the method determines the orientation of the well bore 102 by assuming that the well bore 102 will be placed parallel to the direction of maximum stress (overburden stress) in the initial stress field. If the method is determining the placement of fractures in a horizontal well, the method determines the orientation of one of the laterals 104 or 106 to the initial stress field. The orientation of one or more of the laterals 104 or 106 may be input by the user or may be determined by the method. In an exemplary embodiment of the present invention, the method determines the orientation of one or more of the laterals 104 or 106 by assuming that one or more of the laterals 104 or 106 will be orientated parallel to the direction of minimum stress in the initial geological formation.

Referring again to FIG. 5, in step 520, the method of the present invention determines if the next modeled fracture will fail. The next modeled fracture will fail when it propagates in a tortuous path, leading to higher fracture pressure and possibly to sand-out. For example, if a transverse fracture is placed in a lateral of a horizontal well bore, it will fail if it “turns” and begins to propagate in an axial direction. In another example, if an axial fracture is placed in a vertical well bore, it will fail if it “turns” and begins to propagate in a transverse direction. To predict if a fracture will fail, the method of the present invention calculates the geomechanical stresses at the point where the modeled fracture is initiated. To determine the point where the next modeled fracture will be initiated the method may receive input from the user or the method may determine the point where the next modeled fracture will be initiated automatically. In an exemplary embodiment of the present invention, the method assumes that the modeled fractures are equidistant from each other. The method calculates the geomechanical stresses at the point where the next modeled fracture is initiated by summing the initial stress field and the stress fields caused by any previous modeled fractures. After this summation, the method determines which principal component of geomechanical stress is smallest at the point where the modeled fracture is initiated. In the case of a transverse fracture in a lateral of a horizontal well bore, if the minimum stress is the vertical stress then the fracture is deemed to fail. In the case of an axial fracture in a vertical well bore, if the minimum stress is the horizontal stress the fracture is deemed to fail.

An exemplary method for modeling the next fracture, is shown in greater detail in FIG. 7. The method may include modeling the fracture as a semi-infinite crack (block 705, which is discussed in greater detail below) or as a penny-shaped fracture (block 710, which is discussed in greater detail below). In certain embodiments, only one of blocks 705 or 71 0 is used, while in other embodiments both 705 and 710 are used and the method further interpolates between the two models. The method includes modeling the surface deformation caused by the next fracture (block 715, which is discussed in greater detail below).

In certain embodiments, the method selects a model to use to model the fracture. The selection of one of the models may be accomplished with or without user intervention. In an exemplary embodiment of the present invention, the user manually selects a model to use for modeling the next modeled fracture and inputs the dimension of the fracture. In another embodiment of the present invention, there is a default fracture model used to model the next modeled fracture. In yet another embodiment of the present invention, the method will determine which model is most appropriate for modeling the next modeled fracture based on the input characteristics of the next modeled fracture and previously modeled fractures (e.g., the distance between fractures, the size of the fracture, and the shape of the fracture).

Regardless of the method used to model the next modeled fracture, the method of the present invention may consider properties of the geological formation (e.g., type of material and presence of naturally occurring fractures) while modeling the next modeled fracture. In an exemplary embodiment of the present invention the method considers the presence of naturally occurring fractures in the geological formation. The presence of these fractures may reduce the stress induced by the previously modeled fractures on the next modeled fracture.

When modeling the next modeled fracture as a semi-infinite crack in step 705, the method of the present invention assumes that next modeled fracture is rectangular, with an infinite length, a finite height, and a width that is extremely small compared with the height and the length of the fracture. The height of the next modeled fracture may be input by the user or may be determined by the method. In an exemplary embodiment of the present invention, the method assumes that the modeled fractures have equal dimensions, and optimizes the size of the fractures to maximize the geological maximum number of fractures. Using these assumptions the method of the present invention calculates the stress field caused by the next modeled fracture using the following equations:

$$\begin{matrix}\frac{1}{2} ( {σ}_{y} + {σ}_{x} ) = {p}_{o} \{ \frac{r}{\sqrt{{r}_{1} {r}_{2}}} cos ( θ - 0.5 {θ}_{1} - 0.5 {θ}_{2} ) - 1 \} & ( Equation 1 ) \\ \frac{1}{2} ( {σ}_{y} - {σ}_{x} ) = {p}_{o} \frac{2 r cos θ}{H} {( \frac{{H}^{2}}{4 {r}_{1} {r}_{2}} )}^{3 / 2} cos ( \frac{3}{2} ( {θ}_{1} + {θ}_{2} ) ) & ( Equation 2 ) \\ {τ}_{xy} = - {p}_{o} \frac{2 r cos θ}{H} {( \frac{{H}^{2}}{4 {r}_{1} {r}_{2}} )}^{3 / 2} sin ( \frac{3}{2} ( {θ}_{1} + {θ}_{2} ) ) & ( Equation 3 ) \\ {σ}_{z} = μ ( {σ}_{x} + {σ}_{y} ) & ( Equation 4 )\end{matrix}$$

where: σₓ, σ_{y}, and σ_{z} are the components of stress in the x, y, and z directions respectively; τ_{xy} is the shearing stress; p₀ is the internal pressure at the point where the fracture is initiated; H is the height of the fracture ; μ is the rigidity ratio of the formation; and where

$$z = r {e}^{i θ} , z - \frac{1}{2} H = {r}_{1} {e}^{i {θ}_{1}} , z + \frac{1}{2} H = {r}_{2} {e}^{i {θ}_{2}} .$$

The method also records a predicted fracturing pressure associated with the next modeled fracture. In an exemplary embodiment of the present invention, the predicted fracturing pressure is equal to the internal pressure.

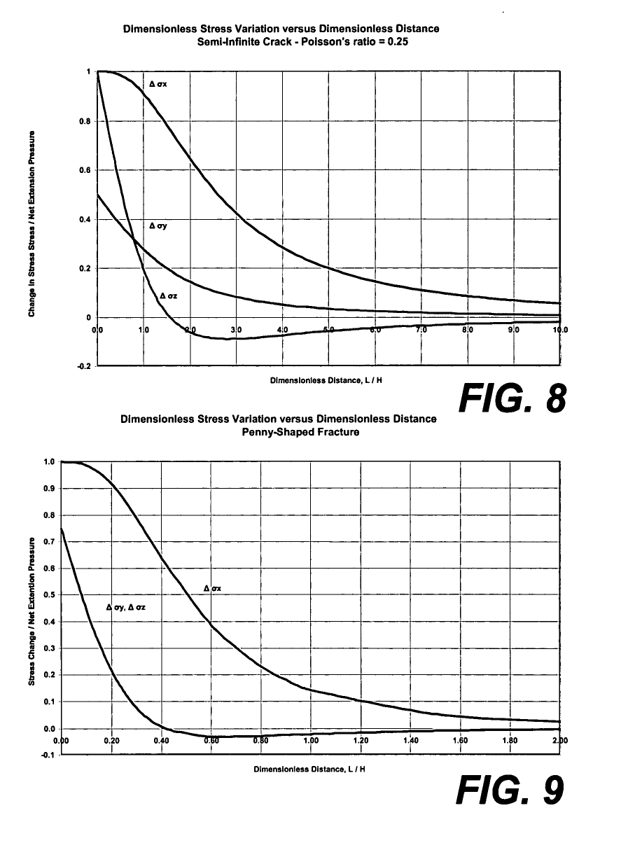

Referring now to FIG. 8, depicted is a graphical representation of the change in the three components of the principal stresses (σₓ, σ_{y}, and σ_{z}) versus the ratio L/H where L is a distance from the fracture along a line of symmetry and H is the height of the fracture. The line of symmetry is used because it represents the horizontal direction in case of creation of multiple fractures from a horizontal well. With respect to the coordinates of the functions plotted in FIG. 8, the x-direction is the direction perpendicular to the created fracture, the y-direction is the horizontal direction parallel to the fracture, and the z-direction is the vertical direction.

Referring again to FIG. 6, when modeling the next modeled fracture as a penny-shaped fracture in step 710, the method of the present invention assumes that the next modeled fracture is circular shaped and has finite dimensions. The height of the next modeled fracture may be input by the user or may be determined by the method. In an exemplary embodiment of the present invention, the method assumes that the modeled fractures have equal dimensions, and optimizes the size of the fractures to maximize the geological maximum number of fractures. Using these assumptions the method of the present invention calculates the stress field caused by the next modeled fracture using the following equations:

$$\begin{matrix}{σ}_{r} = \frac{2 {p}_{0} }{π} {( \frac{c}{2 δ} )}^{\frac{1}{2}} [ \frac{3}{4} cos \frac{1}{2} Ψ + \frac{1}{4} cos \frac{5}{2} Ψ ] & ( Equation 5 ) \\ {σ}_{z} = \frac{2 {p}_{0}}{π} {( \frac{c}{2 δ} )}^{\frac{1}{2}} [ \frac{5}{4} cos \frac{1}{2} Ψ - \frac{1}{4} cos \frac{5}{2} Ψ ] & ( Equation 6 ) \\ {τ}_{zr} = \frac{{p}_{0}}{π} {( \frac{c}{2 δ} )}^{\frac{1}{2}} sin Ψ cos \frac{3}{2 } Ψ & ( Equation 7 ) \\ {σ}_{θ} = \frac{4 σ {p}_{0} }{π} {( \frac{c}{2 δ} )}^{\frac{1}{2}} cos \frac{1}{2} Ψ & ( Equation 8 )\end{matrix}$$

where: σᵣ, σ_{z}, and σ₀ are the polar components of stress; τ_{z}, is the shearing stress; p₀ is the internal at the point where the fracture is initiated; z=reⁱ⁰, z−c=r₁eⁱ⁰, and z+c=r₂eⁱ⁰^{₁}, where the fracture extends from z=c to z=−c; and where a two-dimensional projection of the fracture is defined by the function η²=bξ, where the origin of the coordinates is the edge of the fracture, ξ is the axis along the fracture, η is the axis perpendicular to the fracture, ξ=δ cos Ψ, and η=δ sin Ψ. The equations are provided in this coordinate set for brevity. One of ordinary skill in the art with the benefit of this disclosure can convert the coordinates and solve for σₓ, σ_{y}, and σ_{y}. The method also records a predicted fracturing pressure associated with the next modeled fracture. In an exemplary embodiment of the present invention, the predicted fracturing pressure is equal to the internal pressure.

Referring now to FIG. 9, depicted is a graphical representation of the change in the three principal stresses (σₓ, σ_{y}, and σ_{z}) versus the dimensionless distance L/H where L is the distance from the fracture and H is the diameter of the fracture for the penny-shaped fracture. With respect to the coordinates of the functions plotted in FIG. 9, the x-direction is the direction perpendicular to the created fracture, the y-direction is the horizontal direction parallel to the fracture, and the z-direction is the vertical direction.

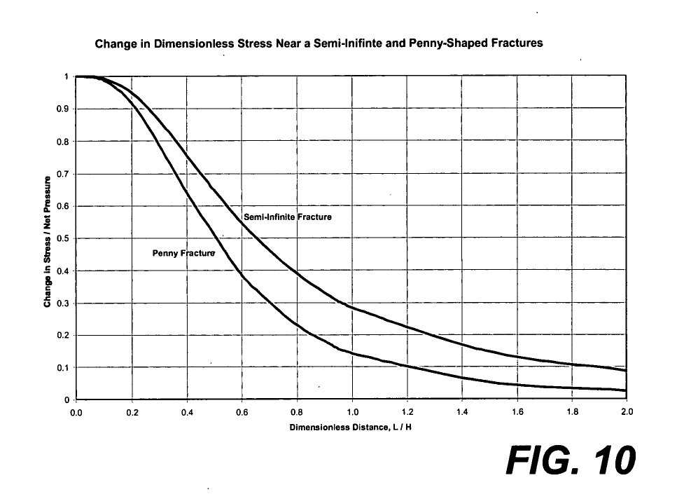

Referring now to FIG. 10, depicted is a graphical representation of the change in minimum horizontal stress (the stress component perpendicular to the fracture) due to the creation of a semi-infinite fracture versus dimensionless distance from the fracture and the change in minimum horizontal stress due to the creation of a penny-shaped fracture versus dimensionless distance from the fracture. The dimensionless distance from the fracture is the ratio of the distance from the fracture versus the height or diameter of the fracture.

The method according to the present invention may use other geomechanical models to model the next modeled fracture. In one exemplary embodiment of the present invention, the method may model the fractures as both a semi-infinite fracture (as in step 705) and as a penny-shaped fracture (as in step 710) and interpolate between the modeled stress fields (e.g., the penny-shaped and semi-infinite stress fields) based on one or more properties of the next modeled fracture (e.g., the length of the next modeled fracture or the shape of the next modeled fracture) to determine a stress field for the modeled fracture. In an exemplary embodiment of the present invention the dimensions of the next modeled fracture are input by the user. In another exemplary embodiment of the present invention, the method assumes that the modeled fractures have equal dimensions, and optimizes the size of the fractures to maximize the geological maximum number of fractures. The method may assign a weight to the length and diameter/height of the fracture. In that case, stress field induced by a longer fracture will more closely resemble the stress field induced by a semi-infinite fracture than a shorter fracture, assuming all other dimensions of the longer and shorter fractures are equivalent. The method also records a predicted fracturing pressure associated with the next modeled fracture. In an exemplary embodiment of the present invention, the predicted fracturing pressure is equal to the internal pressure.

Modeling each fracture (block 515) includes determining a new stress field in the subterranean formation due to the next fracture. One example method of determining the new stress field sums the initial stress field, the stress fields caused by previously modeled fractures, and the stress field case by the next modeled fracture. In an exemplary embodiment of the present invention, it is assumed that the medium is linearly elastic and that the governing model of the stress field (comprising the differential equations, boundary conditions, and initial conditions) is linear, the principle of superposition is applicable. Thus, the method of the present invention may calculate the new stress field by summing the stresses caused by each of the fractures on the specific point in the formation.

In another exemplary embodiment of the present invention, the method may calculate the stress field by using superposition and by adding the initial stress field, the stress fields caused by each of previously modeled fractures, and the next modeled fracture, sequentially. This has the effect of predicting a greater change in the minimum stress because each modeled fracture will be created against a higher minimum stress (due to the presence of the previously modeled stress fields). Because the minimum stress will be higher for each subsequent fracture, the internal pressure at the point where the subsequent fracture is initiated will be higher. Consequently, a higher fracturing pressure will be required to create each subsequent fracture to overcome the internal pressure of the formation. The increase in p₀ will, in turn, lead to a greater change in the minimum stress caused by the next modeled fracture.

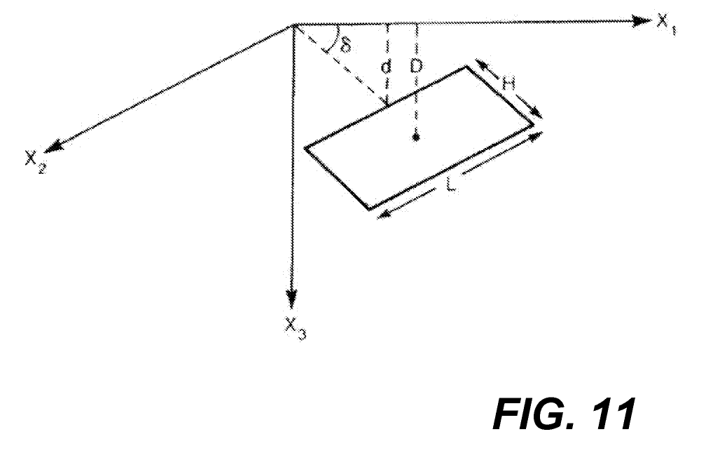

As discussed with respect to FIG. 7, the method includes modeling the surface deformation caused by each of the fractures (block 715). The surface deformation caused by each fracture may be modeled using analytical methods. In one example implementation, the fracture is approximated as a rectangular cut in an elastic half-space and a displacement of the walls of the half-space by a constant distance normal to the plane of the cut. An example geometry and coordinate system for such an implementation are shown in FIG. 11. The vertical surface displacement field (w) caused by the rectangular cut in the elastic half-space and displacement of the wells is given by the following indefinite integral:

$$\begin{matrix}w = {u}_{3} ( {X}_{1} , {X}_{2} , 0 ) \\ = \frac{b}{2 π} [ \begin{matrix}2 ( 1 - v ) ( - \frac{B}{{X}_{1}} {tan}^{- 1} ( \frac{UV}{A ρ} ) - \\ \frac{{{A}^{3} ( U + B )}^{2} V}{{X}_{1}^{3} ( {U}^{2} + {A}^{2} ) ρ} ) + \\ \frac{BAV ( {A}^{2} - UB ) ( U + B )}{( {U}^{2} + {A}^{2} ) ρ {X}_{1}^{3}} - \\ ( 1 - 2 v ) \frac{B}{{X}_{1}} {tan}^{- 1} ( \frac{{VX}_{1}}{{A}^{2} - UB} ) + \\ ( 1 - 2 v ) \frac{B}{{X}_{1}} {tan}^{- 1} ( \frac{( U + B ) VA}{( {A}^{2} - UB ) ρ} ) + \\ \frac{VA ( {V}^{2} + {A}^{2} - BU )}{{X}_{1} ρ ( {V}^{2} + {A}^{2} )} + \\ ( 1 - 2 v ) \frac{{X}_{1}}{B} {tan}^{- 1} ( \frac{BU - {A}^{2}}{{VX}_{1}} ) + \\ ( 1 - 2 v ) \frac{{X}_{1}}{B} {tan}^{- 1} ( \frac{( {V}^{2} + {A}^{2} - BU ) A}{BV ρ} )\end{matrix} ]\end{matrix} \qquad ( Equation 9 )$$

where: v is Poisson's ratio,

A=X₁ sin δ, (Equation 10)

B=X₁ cos δ, (Equation 11)

U=ξ−X₁ cos δ, (Equation 12)

V=ξ₁−X₂, (Equation 13)

U=ξ−X₁ cos δ, (Equation 14)

and where

f(U,V)∥=f(U₂, V₂)−f(U₂, V₁)−f(U₁, V₂)+f(U₁, V₁), (Equation 15)

where U₂ and V₂ are the upper limits of integration and U₁ and V₁ are the lower limits of integration. ξ and ξ₂ represent coordinates within the rectangular cut where the coordinate ξ is measured positive down the fault dip

$$( δ ) , - \frac{H}{2} \leq ξ \leq \frac{H}{2} ,$$

and −l≦ξ₂≦l where L=2l. For the geometry shown in FIG. 11:

$$\begin{matrix}{U}_{1} = \frac{D}{sin δ} - \frac{H}{2} - {X}_{1} cos δ , & ( Equation 16 ) \\ {U}_{2} = \frac{D}{sin δ} + \frac{H}{2} - {X}_{1} cos δ , & ( Equation 17 ) \\ {V}_{1} = - l - {X}_{2} , & ( Equation 18 ) \\ and & \\ {V}_{2} = l - {X}_{2} & ( Equation 19 )\end{matrix}$$

In certain embodiments, the method may include calculating the new stress field due to the creation of fractures in multiple laterals of a single well. The method may calculate the new stress field for fractures initiated including the stress field induced by fractures 106, 108, and 110 in lateral 104. The method may also calculate the stress field due to adjacent well bores or fractures in adjacent well bores around well bore 102.

In general, the method may use any conventional method to produce the fracture layout. The fracture layout may be generated on a computer and output to a display device or printer. The fracture layout may be controlled by the input of the user or the method may determine the fracture layout automatically. In an exemplary embodiment of the present invention, the method will create the fracture layout so that the fractures are spaced equally from each other. The size of the fractures may be input by the user or the method may determine the size of the fractures automatically.

As described in FIG. 2, the method may include determining the location of one or more tiltmeters to measure the surface deformations caused by the one or more fractures (block 210). In certain embodiments, the method may include placing tiltmeters at surface locations where the greatest deformation is predicted. Those skilled in the art will recall that an array of 12 to over 24 surface tiltmeters is typically placed around a vertical well at radial distances of 15% to 75% of the fracture depth to monitor surface deformation. However, the method recognizes the superposition of stress caused by multiple fractures may potentially expand the area of greatest surface deformation. The method also recognizes that the potential exists for complex fracture shapes to be created. Thus, the method may include placing tiltmeters at a radial distance of up to 100% of the fracture depth away from the initiation point of any single fracture. To avoid redeploying tiltmeters for each fracture 106, 108, and 110, the method may include placing tiltmeters on the surface, arrayed along and to either side of the surface projection of lateral 104, to a distance either side of and past the end of the surface projection of the lateral of up to 100% of the lateral depth. Where the method is used to automatically determine the size of the fractures, tiltmeters placement may be modified by the method so that the tiltmeter array will optimally detect the greatest surface deformation and delineate the overall deformation state caused by the multiple fractures.

FIG. 12 depicts a schematic representation of a subterranean well bore 1212 through which a fluid may be injected into a region of the subterranean formation surrounding well bore 1212 such that real-time fracturing data (e.g., pressure signals, temperature signals, and the like) are generated. The fluid may be of any composition suitable for the particular injection operation to be performed. For example, where the methods of the present invention are used in accordance with a fracture stimulation treatment, a fracturing fluid may be injected into a subterranean formation such that a fracture is created or extended in a region of the formation surrounding well bore 1212 and generates pressure signals. The fluid may be injected by injection device 1201 (e.g., a pump). Physical property data such as pressure signals may be generated during subterranean injection processes, for reasons including the fact that the injected fluid is being forced into the formation at a high pressure. The real-time fracturing data may comprise an actual fracturing pressure, an actual fracturing rate, and an actual fracturing time.

The real-time fracturing data may be sensed using any suitable technique. For example, sensing may occur downhole with real-time data telemetry to the surface, or by delayed transfer (e.g., by storage of data downhole, followed by subsequent telemetry to the surface or subsequent retrieval of the downhole sensing device, for example). In one example method, “smart” proppants may be used to sense downhole, store the data, and transmit the data to a data retrieval device. Furthermore, the sensing of the real-time fracturing data may be performed at any suitable location, including, but not limited to, the tubing 1235 or the surface 1224. In general, any sensing technique and equipment suitable for detecting the desired real-time fracturing data with adequate sensitivity and/or resolution may be used. FIG. 12 depicts an exemplary embodiment of the present invention wherein the real-time fracturing data are sensed by a sensing device 1210 resident within well bore 1212. The sensing device 1210 may be any sensing device suitable for use in a subterranean well bore. An example of a suitable sensing device 1210 is a pressure transducer disclosed in commonly owned U.S. patent application Ser. No. 09/538,536, which is hereby incorporated herein for all purposes. In certain exemplary embodiments of the present invention, the sensing device 1210 comprises a pressure transducer that is temperature-compensated. In one exemplary embodiment of the present invention, the sensing device 1210 is lowered into the well bore 1212 and positioned in a downhole environment 1216. In certain exemplary embodiments of the present invention, the sensing device 1210 may be positioned below perforations 1230. In certain exemplary embodiments of the present invention, the downhole environment 1216 is sealed off by packer 1218, wherein access is controlled with a valve 1220.

The real-time fracturing data is ultimately transmitted to the surface by transmitter 1205 at a desired time after having been sensed by the sensing device 1210. As noted above, such transmission may occur immediately after the real-time fracturing data is sensed, or the data may be stored and transmitted later. Transmitter 1205 may comprise a wired or wireless connection. In one exemplary embodiment of the present invention, the sensing device 12 10, in conjunction with associated electronics, converts the real-time fracturing data to a first electronic signal. The first electronic signal is transmitted through a wired or wireless connection to signal processor unit 1222, preferably located above the surface 1224 at wellhead 1226. In certain exemplary embodiments of the present invention, the signal processor unit 1222 may be located within a surface vehicle (not shown) wherein the fracturing operations are controlled. Signal processor unit 1222 may perform mathematical operations on a first electronic signal, further described later in this application. In certain exemplary embodiments of the present invention, signal processor unit 1222 may be a computer comprising a software program for use in performing mathematical operations. An example of a suitable software program is commercially available from The Math Works, Inc., of Natick, Mass. , under the tradename “MATLAB.” In certain exemplary embodiments of the present invention, output 1250 from signal processor unit 1222 may be plotted on display 1260.

An example method of receiving real-time fracturing data (block 230, FIG. 2) is shown in FIG. 13. The method includes measuring fracturing pressure while creating a current fracture (block 1305), measuring a fracturing rate while creating a current fracture (block 1310), measuring a fracturing time while creating the current fracture (block 1315), and measuring one or more surface deformations while creating the current fracture (block 1230). In certain exemplary embodiments one or more of block 1305-1315 may be omitted.

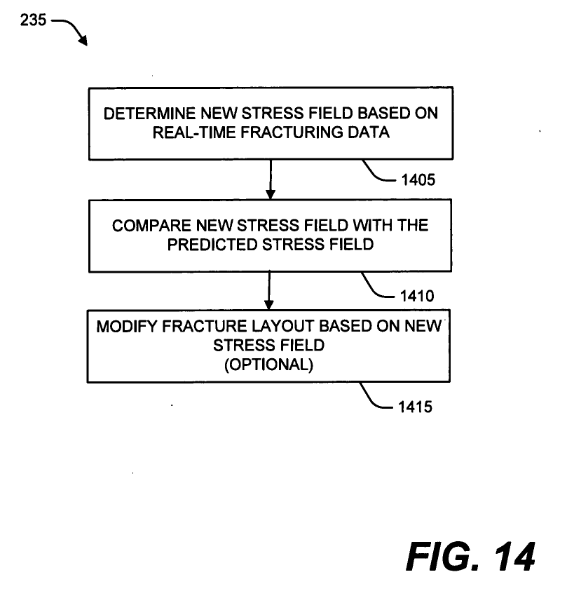

An example method of modifying the fracture layout based on real-time fracturing data (block 235, FIG. 2) is shown in FIG. 14. The method includes determining a new stress field based on the real-time fracturing data (block 1405) and comparing the new stress field with the predicted stress field when the fracture was modeled (block 1410). In some example methods, if the new stress field and the predicted stress field vary from each other, the method may include modifying the fracture layout based on the new stress field (block 1415).

In an exemplary embodiment of the present invention, the method will reevaluate the fracture layout based on the actual fracturing pressure. The method includes remodel fractures that have not been induced. The method may use the method disclosed in block 205 of FIG. 2. The method will substitute the actual fracturing pressure for the internal pressure of the next modeled fracture. Based on the reevaluation of the fracture layout the method may perform any of the following actions: decrease the number of fractures, increase the distance between fractures or decrease the size of the fractures. For example, referring to FIG. 1, assume that fracture 106 is the first fracture induced in lateral 104. If the actual fracturing pressure associated with fracture 106 is greater than the predicted fracturing pressure the method may increase the space between fracture 106 and fracture 108. Assuming the actual fracturing pressure is much greater than the predicted fracturing pressure, the method may omit fracture 108 entirely, reducing the number of fractures in lateral 104.

The methods disclosed above may be carried out by a computer having a processor, a memory, and storage. The methods may be represented as instructions stored in software run on the computer. Additionally, the method may be stored in ROM on the computer.

Therefore, the present invention is well-adapted to carry out the object and attain the ends and advantages mentioned as well as those which are inherent therein. While the invention has been depicted, described, and is defined by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A method of optimizing a number, placement and size of fractures in a subterranean formation, comprising the steps of:
(a) determining one or more geomechanical stresses induced by each fracture based on the dimensions and location of each fracture;
(b) determining a geomechanical maximum number of fractures based on the geomechanical stresses induced by each of the fractures;
(c) determining a predicted stress field based on the geomechanical stresses induced by each fracture; and
(d) determining a predicted surface deformation caused by each fracture.

2. The method according to claim 1, wherein steps (a), (b), (c), and (d) are preformed prior to creating any of the fractures in the subterranean formation.

3. The method according to claim 1, further comprising the steps of:
determining a cost-effective number of fractures;
determining an optimum number of fractures, wherein the optimum number of fractures is the maximum cost-effective number of fractures that does not exceed the geomechanical maximum number of fractures.

4. The method according to claim 1, further comprising the steps of:
creating one or more fractures in the subterranean formation; and
repeating steps (a), (b), and (c) after each fracture is created.

5. The method according to claim 4, wherein the repeating step comprises the steps of gathering and analyzing real-time fracturing data for each fracture created.

6. The method according to claim 5, wherein the gathering of real-time fracturing data comprises the steps of:
(i) measuring a fracturing pressure while creating a current fracture;
(ii) measuring a fracturing rate while creating the current fracture; and
(iii) measuring a fracturing time while creating the current fracture.

7. The method according to claim 5, wherein the gathering of real-time fracturing data comprises the step of:
measuring one or more surface deformations while creating a current fracture.

8. The method according to claim 5, wherein analyzing of real-time fracturing data comprises the steps of:
determining a new stress field, based on the real-time fracturing data; and
comparing the new stress field with the predicted stress field.

9. The method according to claim 1, further comprising the step of determining the location of one or more tiltmeters to measure one or more surface deformations.

10. A computer program, stored on a tangible storage medium, for optimizing a number, placement and size of fractures in a subterranean formation, the program comprising executable instructions that cause at lest one processor to:
(a) determine one or more geomechanical stresses induced by each fracture based on the dimensions and location of each fracture;
(b) determine a geomechanical maximum number of fractures based on the geomechanical stresses induced by each of the fractures;
(c) determine a predicted stress field based on the geomechanical stresses induced by each fracture; and
(d) determine a predicted surface deformation caused by each fracture.

11. The computer program according to claim 10, wherein (a), (b), (c) and (d) are performed prior to creating any of the fractures in the subterranean formation.

12. The computer program according to claim 10, wherein the executable instructions further cause the at least one processor to:
determine a cost-effective number of fractures;
determine an optimum number of fractures, where the optimum number of fractures is the maximum cost-effective number of fractures that does not exceed the geomechanical maximum number of fractures.

13. The computer program according to claim 10, wherein one or more fractures are created in a formation, and wherein the executable instruction further cause the at least one processor to:
repeat (a), (b), (c), and (d) after each fracture is created.

14. The computer program according to claim 13, wherein the executable instruction further cause the at least one processor to:
receive and analyze real-time fracturing data for each fracture created.

15. The computer program according to claim 14, where the executable instruction that cause the at least one processor to analyze real-time fracturing data cause the computer to:
determine a new stress field, based on the real-time fracturing data; and
compare the new stress field with the predicted stress field.

16. The computer program according to claim 14, wherein the real-time fracturing data comprises one or more actual surface deformations, and wherein the executable instructions that cause the computer to analyze the real-time fracturing data for each fracture created cause the at least one processor to:
compare one or more actual surface deformations with one or more predicted surface deformations.

17. The computer program according to claim 10, wherein the executable instructions further cause the at least one processor to determine the location of one or more tiltmeters to measure the one or more surface deformations.

18. A method of fracturing a subterranean formation, comprising the step of:
optimizing a number, placement and size of fractures in the subterranean formation, the step of optimizing comprising:
(a) determining one or more geomechanical stresses induced by each fracture based on the dimensions and location of each fracture;
(b) determining a geomechanical maximum number of fractures based on the geomechanical stresses induced by each of the fractures;
(c) determining a predicted stress field based on the geomechanical stresses induced by each fracture; and
(d) determining a predicted surface deformation caused by the each fracture.

19. The method according to claim 18, further comprising the steps of:
creating one or more fractures in the subterranean formation; and
repeating substeps (a), (b), and (c) of the optimizing step after each fracture is created.

20. The method according to claim 19, wherein the repeating step further comprises the steps of:
gathering real-time fracturing data for each fracture created, wherein the real-time fracturing data comprises one or more actual surface deformations; and
comparing one or more actual surface deformations with one or more predicted surface deformations.

21. The method of claim 18, further comprising the step of determining the location of one or more tiltmeters to measure the one or more predicted surface deformations.
